(19) United States
(12) Patent Application Publication
(10) Pub. No.: US 2012/0092775 A1
(43) Pub. Date: Apr. 19, 2012

(54) Systems, Devices, and/or Methods for Managing Variable Power Fluidic Lens

(75) Inventors: Dwight Duston, Laguna Niguel, CA (US); Anthony Van Heugten, Sarasota, FL (US)

(73) Assignee: E-VISION, LLC, Roanoke, VA (US)

(21) Appl. No.: 13/274,527

(22) Filed: Oct. 17, 2011

Related U.S. Application Data
(60) Provisional application No. 61/393,465, filed on Oct. 15, 2010.

(51) Int. Cl. G02B 3/14; G02B 3/12

(52) U.S. Cl. 359/666; 359/665

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, transitioning an optical power of a fluidic lens over a substantially continuous range.

### CROSS-REFERENCES TO RELATED APPLICATIONS

This application claims priority to pending U.S. Provisional Patent Application 61/393465 (Attorney Docket (1149-014)), filed 15 Oct. 2010.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a block flow diagrams of an exemplary embodiment of a variable focus fluidic lens system 1000;

FIG. 2 is a block flow diagrams of an exemplary embodiment of a variable focus fluidic lens system 1000;

FIG. 3 is a block flow diagrams of an exemplary embodiment of a variable focus fluidic lens system 1000;

FIG. 4 is a block diagram of an exemplary embodiment of a system 4000;

FIG. 5 is a block diagram of an exemplary embodiment of a fluid control system 5000 for a fluidic lens system 1000;

FIG. 6 is a flowchart of an exemplary embodiment of a method; and

FIG. 7 is a block diagram of an exemplary embodiment of an information device.

### DETAILED DESCRIPTION

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, transitioning an optical power of a fluidic lens over a substantially continuous range.

Fluidic lenses can be one means for creating optical elements with variable focus. By employing techniques that can change the shape of a cavity and/or volume of a fluid in the cavity, a variable focus lens can be fabricated. Fluidic variable focus lenses can achieve very large optical powers (short focal lengths). However, most fluidic lenses are typically limited to adding optical power, that is, acting as converging lenses. Providing negative power (i.e., acting as diverging lenses) has proved difficult.

Certain exemplary embodiments can provide a fluidic lens that can provide positive optical powers and/or negative optical powers (i.e., can be capable of being operated in converging and/or diverging mode) by pumping two different fluids into respective portions of a partitioned cavity. The cavity can contain substantially one of either fluid or a combinative fraction of each fluid simultaneously. The design of such a fluidic lens is described below.

FIG. 1 is a block flow diagrams of an exemplary embodiment of a variable focus fluidic lens system 1000. As shown in FIG. 1, a first portion 1350 of a cavity 1800 can be formed by a non-porous membrane 1500 and a first optical surface 1150 of a first substrate 1100. The first portion 1350 of the cavity 1800 can be filled with a first optical fluid 1300, which can be provided to and/or removed from the cavity 1800 via a first feed line 1600. As shown in FIG. 1, a second optical fluid 1400 can be substantially withdrawn from a second portion 1450 of the cavity 1800 defined by second optical surface 1250 and non-porous membrane 1500, via a second feed line 1700. The non-porous membrane 1500 can be substantially in contact with the second optical surface 1250 of the second substrate 1200. The non-porous membrane 1500, when substantially in contact with the second optical surface 1250, can take on a substantially similar shape to the second optical surface 1250.

FIG. 2 is a block flow diagram of an exemplary embodiment of a variable focus fluidic lens system 1000 which can be the same as system 1000 of FIG. 1. As shown in this figure, both the first optical fluid 1300 and the second optical fluid 1400 can substantially occupy the cavity 1800, wherein the first optical fluid 1300 can be located in a first portion 1350 of the cavity 1800 and the second optical fluid 1400 can be located in a second portion 1450 of the cavity 1800. Each of fluid 1300 and fluid 1400 can be partitioned from the other by the non-porous membrane 1500. The non-porous membrane 1500 appears flat and/or planar in FIG. 2, but it can be substantially spherical and/or substantially resemble a segment of a sphere when unequal pressures and/or a pressure differential is applied across membrane 1500 by the first optical fluid 1300 (which can be provided via first feed line 1600) and the second optical fluid 1400 (which can be provided via second feed line 1700). The non-porous membrane 1500 also can deform under electro-active control, which can yield an aspheric shape for the non-porous membrane 1500.

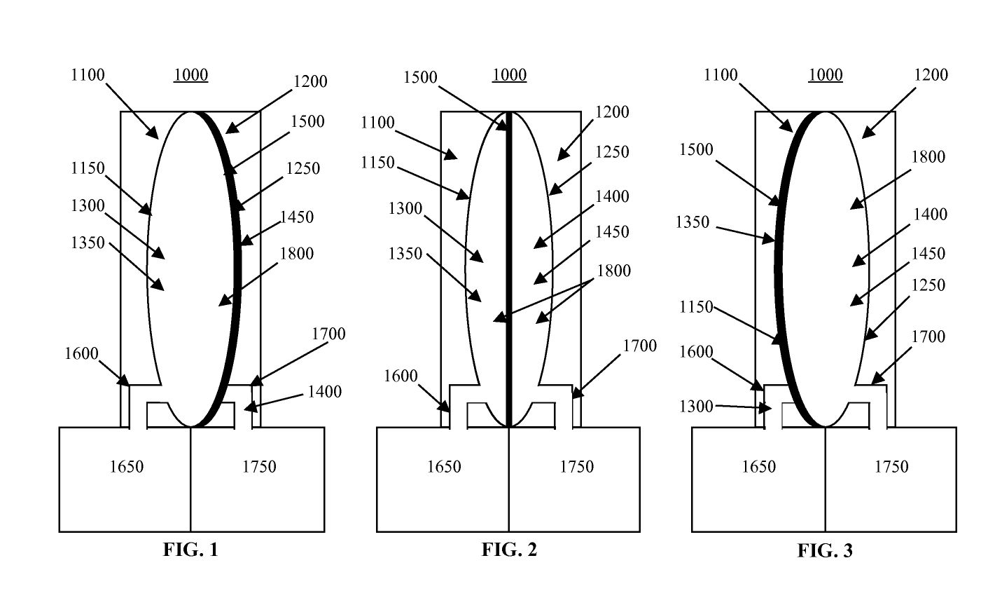

FIG. 3 is a block flow diagram of an exemplary embodiment of a variable focus fluidic lens system 1000 which can be the same as system 1000 of FIG. 1. As shown in this figure, the second optical fluid 1400 can substantially displace the first optical fluid 1300, causing the non-porous membrane 1400 to come into substantial contact with the first optical surface 1150 of first optical substrate 1100, and/or causing non-porous membrane 1400 to assume a substantially similar shape to first optical surface 1150. The first optical fluid 1300 can be withdrawn from the first portion 1350 of the optical cavity 1800 via first feed line 1600. The second optical fluid 1400 can be provided into the second portion 1450 of the cavity 1800 via second feed line 1700. The second portion 1450 of the cavity 1800 can be formed by the non-porous membrane 1500 and the first optical surface 1250 of the second optical substrate 1200.

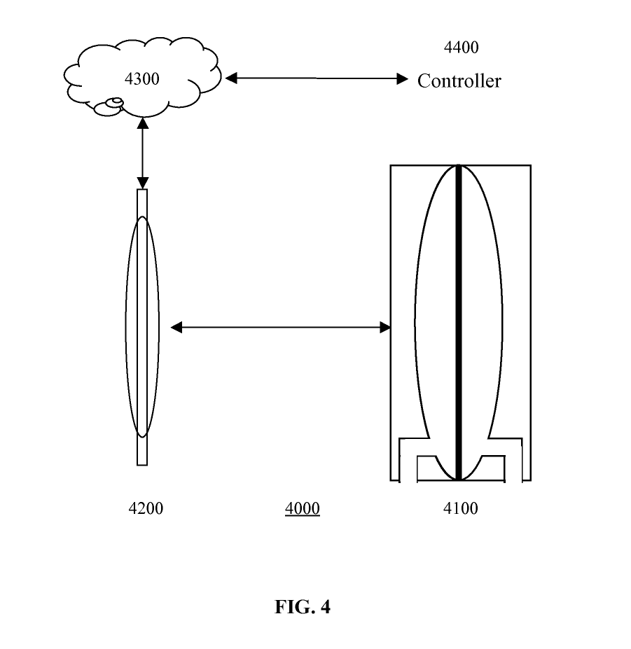

FIG. 4 is a block diagram of an exemplary embodiment of a system 4000. A fluidic lens 4100 can be combined with a tunable variable-focus lens 4200, which can be electro-active. The variable-focus lens 4200 can be connected via a network 4300 to a tunable variable-focus lens controller 4400.

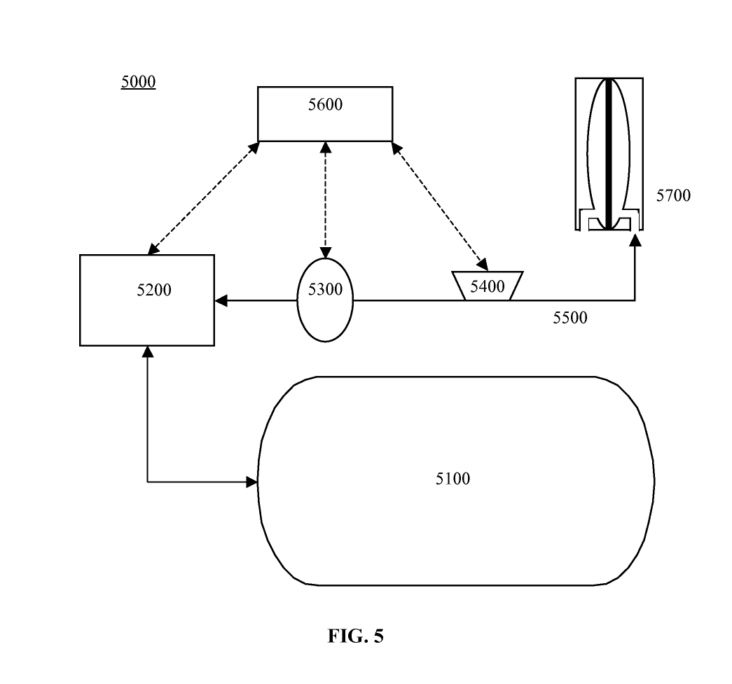

FIG. 5 is a block diagram of an exemplary embodiment of a fluid control system 5000, such as for a variable focus fluidic lens system 1000 of FIG. 1. Fluid control system 5000 can include a controller 5600, which can receive measurements from a sensor, such as a sensor 5400 that detects and/or measures a variable such as pressure, level, strain, and/or flow, etc. In response to receiving a signal encoding a sensed variable, controller 5600 can control valve 5300 and/or activate, deactivate, and/or control a speed of an electrically driven pump 5200 to provide and/or control the flow of optical fluid from reservoir 5100 to fluidic and/or variable focus lens 5700 and/or to provide optical fluid from fluidic and/or variable focus lens 5700 to reservoir 5100.

Referring to FIG. 2, in certain exemplary embodiments, two partially hollow concave substrates 1100, 1200, potentially made of plastic or glass, can enclose a cavity 1800. The concave surfaces 1150, 1250 that bound cavity 1800 can be spherical (i.e., have a substantially constant radius of curvature), parabolic, and/or some other arbitrary aspheric shape. Substrates 1100, 1200 can be formed by means that can provide a molded, cast, forged, machined, and/or otherwise formed single, monolithic, continuous, and/or one-piece hollow optic, and/or two separate monolithic and/or continuous pieces that can be joined together with glue, bolts, bracings, etc.

A substantially flexible and/or non-porous membrane 1500 can be attached to substrates 1100, 1200 at the circumference and/or periphery of cavity 1800 such that membrane 1500 can flex under pressure to ultimately substantially conform to one of cavity surfaces 1150, 1250. Membrane 1500 can be attached to some portion of substrates 1100, 1200 by some means potentially including an adhesive and/or press fit in between the substrates 1100, 1200. Membrane 1500 can be stretchable to potentially allow it to flex under pressure and/or can be substantially taut when in the un-flexed configuration shown in FIG. 2. Membrane 1500 can be made of a number of materials including, but not limited to, clear rubber, Mylar™ film, and/or of various polymers such that membrane 1500 can be substantially transparent and/or can have a substantially constant thickness across a substantial portion of its length and/or diameter.

In FIG. 2, feed line 1600 can allow a first fluid 1300 to be pumped from a first reservoir 1650 into and/or out of a first portion 1350 of cavity 1800. A second feed line 1700 can similarly allow a second fluid 1400 to be pumped from a second reservoir 1750 into and/or out of a second portion 1450 of cavity 1800.

With reference to FIG. 1, FIG. 2, and FIG. 3, first fluid 1300 and/or second fluid 1400 can be any number of fluids having different refractive indexes with respect to each other, including, but not limited to, fluorocarbon formulations, methylene iodide formulations, water, air, and/or many other pure liquid and/or fluid formulations.

In FIG. 1, first fluid 1300 can be pumped into the cavity 1800 through feed line 1600, potentially pushing the membrane 1500 substantially fully against the right interior surface 1250 of the substrate 1200, thereby substantially filling the cavity with the first fluid 1300 and forcing substantially all of the second fluid 1400 into a second reservoir 1750.

In FIG. 3, a second fluid 1400 can be pumped into the cavity 1800 through feed line 1700, pushing the membrane substantially fully against the left interior surface of the substrate 1100, thereby substantially filling the entire cavity with the second fluid 1400 and forcing substantially all of the first fluid 1300 into a first reservoir 1650. The amount of each fluid can vary anywhere from zero to substantially filling the cavity.

For example, in FIG. 2 both fluids appear to have been partially pumped into the cavity, and appear to occupy an approximately equal share of the volume of cavity 1800. However, the volume of the first portion 1350 and second portion 1450 of the cavity 1800 can be unequal, manifesting a range of positions anywhere between that shown FIG. 1, FIG. 2, and/or FIG. 3, to provide substantially any predetermined optical power between the full negative power of FIG. 1 to the full positive power of FIG. 3.

If the refractive index (or index of refraction) of the first fluid 1300 is less than the refractive index of the substrates 1100, 1200, then lens 1000 of FIG. 1 is configured to be a negative (diverging) lens. If the refractive index of the second fluid 1400 is greater than that of the substrates 1100, 1200, then lens 1000 of FIG. 3 is configured to be a positive (converging) lens. If the two fluid volumes are carefully adjusted so that the diverging power of the first fluid space cancels the converging power of the second fluid space, as in FIG. 2, then the lens can have approximately zero power, otherwise the optical power of the lens 1000 will have some value between the maximum negative value of lens system 1000 and the maximum positive value of lens system 1000. Typical indices of refraction (n) for the fluids can range from n=1.0 (air) to n=2.31, such as by employing a Refractive Index Liquid Series GH fluid, available from Cargille of Cedar Grove, N.J.

Thus, the resulting lens can provide both negative, zero, and positive powers, depending on the relative volumes of the fluids in the cavity. It should be noted that the total maximum (plus or minus) powers of this fluidic lens can be determined jointly by the shape of the interior cavity surfaces and/or the indices of refraction one and/or both of the two fluids.

Because the inner cavity surfaces can accurately define the fluidic lens shape, the image quality from such a lens, as shown in FIG. 1 and FIG. 3, can potentially be proportional to the surface uniformity of these surfaces. Greater uniformity and/or better image quality can potentially be achieved independently of the diameter of the lens cavity.

It can also be possible for the two fluids to share the cavity volume 1800 of FIG. 2 such that any optical power between the full negative power and full positive power can be achieved. For example, if the cavity design and/or the index of refraction of a first fluid is such that the optical power of the lens 1000 of FIG. 1 is −8 diopters; and if a second fluid has an index of refraction such that the lens 1000 of FIG. 3 has an optical power of +10 diopters, then by varying the amount of each fluid in the cavity, any and every optical power (including any and every fractional optical power) between −8 and +10 diopters can be achievable.

In some cases, a fluidic lens can be combined with a fixed-focus lens to potentially gain further optical power and/or precision. However, this can typically only be done when the shape of the membrane interface in the fluidic lens remains substantially consistently spherical. The membrane interface might not remain consistently spherical if there are membrane variations or potentially minute pressure differences along some portion of the length of the membrane interface.

Potentially, when the volume of the first portion 1350 of the cavity 1800 and the volume of the second portion 1450 of the cavity 1800 can be substantially equal, the shape of the membrane can be substantially flat, as in FIG. 2. When the orientation of the membrane is vertical or has some vertical component, hydrostatic effects of one or more of the optical fluids can cause the membrane to flex in a manner so that the flexed shape differs somewhat from a perfectly spherical shape. Such deviations from a true spherical shape can distort the spatial phase profile of the fluidic lens system and/or cause the fluidic lens system to introduce optical aberrations in an overall optical system comprising that fluidic lens system.

Optical precision can potentially be gained in these situations, where unwanted wavefront aberrations are imparted by the fluidic lens system, by using a variable-focus electro-optic lens located and/or positioned in the same optical path as the fluidic lens 1000, including those that use birefringent liquid crystal to vary the optical power. Unlike fixed-focus lenses, which cannot dynamically correct for changing wavefront aberrations caused by the varying optical power of the fluidic lens, electro-optic lenses can be used in combination with the fluidic lens to substantially correct for any aberration, can create a substantially parabolic and/or substantially aspheric spatial phase profile, etc., from the output wave of the fluidic lens, thereby potentially gaining further optical precision. Exemplary electro-optic lenses that can be used in combination with fluidic lenses are disclosed in U.S. Pat. Nos. 7,475,984, 7,728,949, and 7,744,215, each of which is incorporated herein by reference in its entirety.

The possible applications of the above fluidic lens, with or without an adjunct variable-focus electro-optic lens, can be numerous. A first non-limiting example can include use of fluidic Lenses and/or electro-optic lenses in a Phoropter™ (refractor), the ophthalmic instrument typically used to measure the ocular prescription of the eye by a doctor during an examination. Some or all of the conventional fixed focus lenses in the Phoropter™ (refractor) can be replaced by the fluidic lenses disclosed herein, fluidic lenses in combination with electro-optics, and/or solely electro-optics.

As another example, the fluidic lenses disclosed herein can also be used in photographic and/or video cameras, imaging sensors, and/or telescopes. The fluidic lenses can replace conventional fixed focus and/or adjustable focus lenses to potentially create auto-focus systems and/or zoom (telephoto/wide angle) systems in various applications. The fluidic lenses can be incorporated into spectacles, contact lenses, and/or intra-ocular lenses. In intra-ocular lenses the reservoir 1350 and/or reservoir 1450 can be implanted and/or substituted with the aqueous humour, the vitreous humour, and/or air.

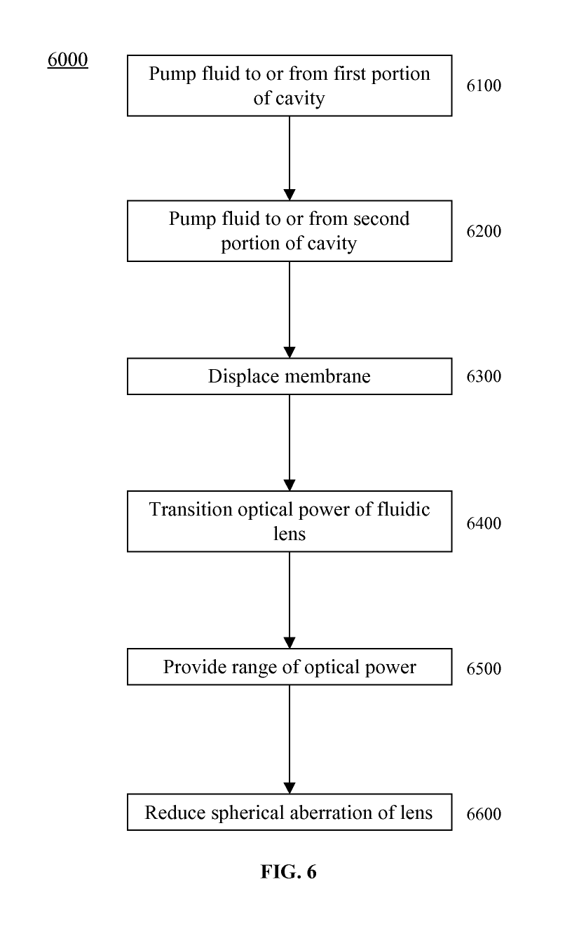

FIG. 6 is a flowchart of an exemplary embodiment of a method 6000. At activity 6100, a first optical fluid can be pumped into and/or out of a first portion of a cavity of a fluidic lens. At activity 6200, a second optical fluid can be pumped into and/or out of a second portion of the cavity. At activity 6300, at least a portion of a membrane of the fluidic lens can be displaced via a pressure differential between the first optical fluid and the second optical fluid. At activity 6400, the displaced membrane can cause a transition in the optical power of the fluidic lens, such as from a positive optical power to a more, or less, positive optical power, or even to a negative optical power. At activity 6500, the fluidic lens can provide a range of optical powers, such as a continuous range between a first predetermined optical power, which can be positive or negative, and a second predetermined optical power, which can be positive or negative. At activity 6600, a spherical aberration imparted by the membrane of the fluidic lens can be reduced, such as via the shape of one or more substrates that define the cavity.

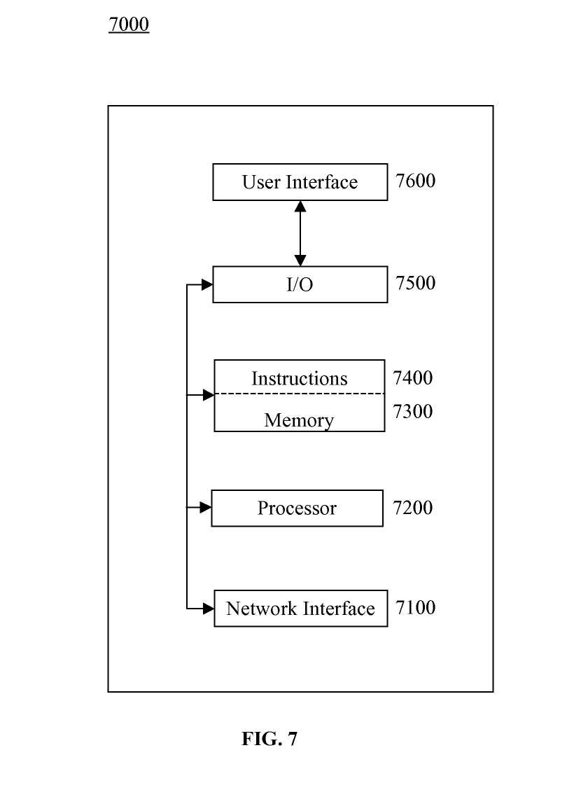

FIG. 7 is a block diagram of an exemplary embodiment of an information device 7000, which in certain operative embodiments can comprise, for example, controller 4400 of FIG. 4 and/or controller 5600 of FIG. 5. Information device 7000 can comprise any of numerous transform circuits, which can be formed via any of numerous communicatively-, electrically-, magnetically-, optically-, fluidically-, and/or mechanically-coupled physical components, such as for example, one or more network interfaces 7100, one or more processors 7200, one or more memories 7300 containing instructions 7400, one or more input/output (I/O) devices 7500, and/or one or more user interfaces 7600 coupled to I/O device 7500, etc.

In certain exemplary embodiments, via one or more user interfaces 7600, such as a graphical user interface, a user can view a rendering of information related to researching, designing, modeling, creating, developing, building, manufacturing, operating, maintaining, storing, marketing, selling, delivering, selecting, specifying, requesting, ordering, receiving, returning, rating, and/or recommending any of the products, services, methods, user interfaces, and/or information described herein.

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to a fluidic lens comprising:
an optical substrate comprising a first portion and a second portion, the first portion of the optical substrate defining a first inner surface and a first outer surface and the second portion of the optical substrate defining a second inner surface and a second outer surface;
a flexible elastic membrane;
a first inner chamber bounded by the first inner surface and the flexible elastic membrane;
a second inner chamber bounded by the second inner surface and the flexible elastic membrane;
a tunable electro-active lens located in the same optical path as the fluidic lens;
a first sensor adapted to detect and/or measure a variable associated with the cavity, the flexible elastic membrane, the first optical fluid, and/or the second optical fluid;
a first controller adapted to control a variable of the cavity, the flexible elastic membrane, the first optical fluid, and/or the second optical fluid.
a first valve adapted to mediate a flowrate of the first optical fluid and/or a flowrate of the second optical fluid; and/or
a first pump adapted to increase a pressure of the first optical fluid and/or the second optical fluid sufficiently to flex the flexible elastic membrane a predetermined amount;
   wherein:
the flexible elastic membrane is adapted to substantially bisect a cavity, the cavity bounded by the first inner surface and the second inner surface;
the flexible elastic membrane is adapted to, in response to being deformed by a first pressure operably generated by a first optical fluid and/or a second pressure operably generated by second optical fluid acting on the flexible elastic membrane: come into substantial contact with the first inner surface, come into substantial contact with the second inner surface, or assume a substantially flat shape and/or substantially spherical shape while substantially contacting neither the first inner surface nor the second inner surface, wherein a radius of the substantially spherical shape is defined by a difference between the first pressure and the second pressure;
an optical power of the fluidic lens is a function of:
   a shape of the first inner surface,
   a shape of the second inner surface,
   a volume of the first optical fluid in a first inner chamber bounded by the first inner surface and the flexible elastic membrane,
   a volume of the second optical fluid in a second inner chamber bounded by the second inner surface and the flexible elastic membrane,
   a refractive index of the first optical fluid,
   a refractive index of the second optical fluid;
the first inner surface defines a substantially parabolic shape;
the second inner surface defines a substantially parabolic shape;
the optical substrate defines a first outer surface and a second outer surface;
the first outer surface and/or the second outer surface are adapted to be substantially planar shaped;
the optical substrate is solid;
a refractive index of the first optical fluid is different from a refractive index of the second optical fluid;
the refractive index of the first optical fluid is less than a refractive index of the optical substrate;
the refractive index of the second optical fluid is greater than the refractive index of the optical substrate;
the optical substrate comprises a first channel adapted to convey the first optical fluid into and/or out of the first inner chamber;
the optical substrate comprises a second channel adapted to convey the second optical fluid into and/or out of the second inner chamber;
a refractive index of the first optical fluid is different from a refractive index of the second optical fluid;the refractive index of the first optical fluid is less than a refractive index of the first portion of the optical substrate and/or a refractive index of the second portion of the optical substrate;
the refractive index of the second optical fluid is greater than the refractive index of the second portion of the optical substrate and/or the refractive index of the first portion of the optical substrate; and/or
a refractive index of the first portion of the optical substrate is the same as a refractive index of the second portion of the optical substrate.

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to:
transitioning an optical power of a fluidic lens from a positive value to a negative value over a substantially continuous range of values;
providing the substantially continuous range of optical powers, a spherical aberration at each optical power within said range of optical powers less than a spherical aberration of a perfectly spherical lens having a continuously uniform radius;
causing a predetermined point on the flexible elastic membrane to displace by a predetermined amount in a predetermined direction;
pumping the first optical fluid into the first portion of the cavity;
pumping the first optical fluid out of the first portion of the optical cavity;
pumping the second optical fluid into the second portion of the cavity; and/or
pumping the second optical fluid out of the second portion of the optical cavity;
   wherein:
entry of a first optical fluid into a first portion of a cavity substantially displaces a second optical fluid from a second portion of the cavity;
the first portion of the cavity is defined by a first portion of an optical substrate and a flexible elastic membrane;
the second portion of the cavity is defined by a second portion of the optical substrate and the flexible elastic membrane;
the first optical fluid is partitioned from the second optical fluid by the flexible elastic membrane;
the flexible elastic membrane is comprised of a substantially optically transmissive material;
the first portion and/or the second portion of the of the optical substrate are comprised of a substantially optically transmissive material;
the first optical fluid has a refractive index less than the refractive index of the first portion of the optical substrate;
the second optical fluid has a refractive index greater than the refractive index of the first portion of the optical substrate;
at a predetermined maximum positive value of the optical power the flexible elastic membrane is substantially in contact with a first inner surface of the first portion of the optical substrate;
at a predetermined maximum negative value of the optical power the flexible elastic membrane is substantially in contact with a second inner surface of the second portion of the optical substrate; and/or
the first inner surface of the first portion of the optical substrate and/or the second inner surface of the second portion of the optical substrate are parabolic in shape.

### Definitions

When the following phrases are used substantively herein, the accompanying definitions apply. These phrases and definitions are presented without prejudice, and, consistent with the application, the right to redefine these phrases via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
aberration—the failure of rays to converge at one focus because of limitations and/or defects in an optical component contacted by the rays, such as a lens and/or mirror, such limitations and/or defects due to, e.g., the use of spherical surfaces.
act—to perform a deed, act, and/or activity; to take action and/or to do something; to behave in a way specified; to fulfill a function and/or serve a purpose of; to take effect; to have a particular effect.
action—a deed, act, activity, performance of a deed, act, and/or activity, and/or something done and/or accomplished.
activity—an action, act, step, and/or process or portion thereof.
adapted to—suitable, fit, and/or capable of performing a specified function.
adapter—a device used to effect operative compatibility between different parts of one or more pieces of an apparatus or system.
adapter—a device used to effect operative compatibility between different parts of one or more pieces of an apparatus or system.
along—through, on, beside, over, in line with, and/or parallel to the length and/or direction of; and/or from one end to the other of
and/or—either in conjunction with or in alternative to.
apparatus—an appliance or device for a particular purpose
are—to exist.
associate—to join, connect together, and/or relate.
assume—to take on a responsibility and/or role.
automatic—performed via an information device in a manner essentially independent of influence and/or control by a user. For example, an automatic light switch can turn on upon “seeing” a person in its “view”, without the person manually operating the light switch.
be—to exist in actuality; to have a specified state, quality, identity, nature, and/or role, etc.
between—in a separating interval and/or intermediate to.
bisect—to divide into two parts
Boolean logic—a complete system for logical operations.
bound—to limit.
by—via and/or with the use and/or help of.
can—is capable of, in at least some embodiments.
cause—to bring about, provoke, precipitate, produce, elicit, be the reason for, result in, and/or effect.
cavity—a hollow area, such as a hole, bore, etc., within an object.
chamber—a space and/or compartment that is at least partially defined and surrounded by one or more objects.
channel—(v) to cause to flow via a defined passage, conduit, and/or groove adapted to convey one or more fluids. (n) a passage, conduit, and/or groove adapted to convey one or more fluids.
circuit—a physical system comprising, depending on context: an electrically conductive pathway, an information transmission mechanism, and/or a communications connection, the pathway, mechanism, and/or connection established via a switching device (such as a switch, relay, transistor, and/or logic gate, etc.); and/or an electrically conductive pathway, an information transmission mechanism, and/or a communications connection, the pathway, mechanism, and/or connection established across two or more switching devices comprised by a network and between corresponding end systems connected to, but not comprised by the network.
claim—(n) an assertion of a right to and/or responsibility for something; (v) to assert a right to and/or responsibility for something.
come—to move and/or travel toward and/or into a place thought of as near; to arrive at a specified place; to reach and/or extend to a specified point; and/or to approach.
communicatively—linking in a manner that facilitates communications.
complex conjugate—each of two complex numbers having their real parts identical and their imaginary parts of equal magnitude but opposite sign.
comprise—to consist of, be made up of, include, and/or be a part of, but not to be limited to.
comprising—including but not limited to.
configure—to make suitable or fit for a specific use or situation.
connect—to join or fasten together.
constant—continually occurring; persistent; unchanging; and/or substantially invariant over time.
contact—to touch and/or come together.
containing—including but not limited to.
continuous—in a manner substantially uninterrupted in time, sequence, substance, and/or extent, and/or substantially without cessation.
control—(n) a mechanical or electronic device used to operate a computer and/or machine within predetermined limits; (v) to exercise authoritative and/or dominating influence over, cause to act in a predetermined manner, direct, adjust to a requirement, and/or regulate.
controller—a device and/or set of machine-readable instructions for performing one or more predetermined and/or user-defined tasks. A controller can comprise any one or a combination of hardware, firmware, and/or software. A controller can utilize mechanical, pneumatic, hydraulic, electrical, magnetic, optical, informational, chemical, and/or biological principles, signals, and/or inputs to perform the task(s). In certain embodiments, a controller can act upon information by manipulating, analyzing, modifying, converting, transmitting the information for use by an executable procedure and/or an information device, and/or routing the information to an output device. A controller can be a central processing unit, a local controller, a remote controller, parallel controllers, and/or distributed controllers, etc. The controller can be a general-purpose microcontroller, such the Pentium IV series of microprocessor manufactured by the Intel Corporation of Santa Clara, Calif., and/or the HC08 series from Motorola of Schaumburg, Ill. In another embodiment, the controller can be an Application Specific Integrated Circuit (ASIC) or a Field Programmable Gate Array (FPGA) that has been designed to implement in its hardware and/or firmware at least a part of an embodiment disclosed herein.
convert—to transform, adapt, and/or change.
convey—to transmit, transport, guide, and/or carry.
coupleable—capable of being joined, connected, and/or linked together.
coupled—connected or linked by any known means, including mechanical, fluidic, acoustic, electrical, magnetic, and/or optical, etc.
coupling—linking in some fashion.
create—to bring into being.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, and/or structure of.
deform—to distort the shape and/or form of; to make misshapen; to become distorted and/or misshapen; and/or to undergo deformation.
determine—to find out, obtain, calculate, decide, deduce, ascertain, and/or come to a decision, typically by investigation, reasoning, and/or calculation.
device—a machine, manufacture, and/or collection thereof.
difference—a value obtained via a subtraction of a first quantity from a second quantity.
different—changed, distinct, and/or separate.
digital—non-analog and/or discrete.
displace—to take over the place, position, and/or role of something; and/or to cause something to move from its proper and/or usual place.
elasticity—a property of returning to an initial form or state following deformation.
electrical—relating to producing, distributing, and/or operating by electricity.
electro-active—a branch of technology concerning the interaction between the material (physical) properties and the electrical (electronic) states of materials and/or involving components, devices, systems, and/or processes that operate by modifying the material properties of a material by applying to it an electrical field and/or magnetic field. Sub-branches of this technology include, but are not limited to, electro-optics.
electro-active element—an component that utilizes an electro-active effect, such as an electro-active filter, reflector, lens, shutter, a liquid crystal retarder, an active (i.e., non-passive) polarity filter, an electro-active element that is movable via an electro-active actuator, and/or a conventional lens movable by an electro-active actuator.
electro-optic—a branch of technology concerning the interaction between the electromagnetic (optical) and the electrical (electronic) states of materials and/or involving components, devices, systems, and/or processes that operate by modifying the optical properties of a material by applying to it an electrical field.
entry—the act of entering.
estimate—(n) a calculated value approximating an actual value; (v) to calculate and/or determine approximately and/or tentatively.
first—an initial entity in an ordering of entities and/or immediately preceding the second in an ordering.
flexible—capable of being bent or flexed; pliable.
fluid—a gas and/or liquid.
follow—to take place at a later time.
from—used to indicate a source, origin, and/or location thereof.
function—(n) a defined action, behavior, procedure, and/or mathematical relationship. (v) to perform as expected when applied.
further—in addition.
generate—to create, produce, give rise to, and/or bring into existence.
greater than—larger in magnitude.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
have—to be made up of; comprise.
having—including but not limited to.
human-machine interface—hardware and/or software adapted to render information to a user and/or receive information from the user; and/or a user interface.
including—including but not limited to.
information device—any device capable of processing data and/or information, such as any general purpose and/or special purpose computer, such as a personal computer, workstation, server, minicomputer, mainframe, supercomputer, computer terminal, laptop, tablet computer (such as an iPad-like device), wearable computer, Personal Digital Assistant (PDA), mobile terminal, Bluetooth device, communicator, “smart” phone (such as an iPhone-like device), messaging service (e.g., Blackberry) receiver, pager, facsimile, cellular telephone, traditional telephone, telephonic device, embedded controller, programmed microprocessor or microcontroller and/or peripheral integrated circuit elements, ASIC or other integrated circuit, hardware electronic logic circuit such as a discrete element circuit, and/or programmable logic device such as a PLD, PLA, FPGA, or PAL, or the like, etc. In general, any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc. In information device can be a component of and/or augment another device, such as an appliance, machine, tool, robot, vehicle, television, printer, “smart” utility meter, etc.
initialize—to prepare something for use and/or some future event.
inner—closer than another to the center and/or middle.
input/output (I/O) device—any device adapted to provide input to, and /or receive output from, an information device. Examples can include an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, switch, relay, haptic device, vibrator, tactile simulator, and/or tactile pad, potentially including a port to which an I/O device can be attached or connected.
install—to connect or set in position and prepare for use.
instructions—directions, which can be implemented as hardware, firmware, and/or software, the directions adapted to perform a particular operation and/or function via creation and/or maintenance of a predetermined physical circuit.
intersection—a point and/or line segment defined by the meeting of two or more items.
into—toward, in the direction of, and/or to the inside of
lens—a piece of transparent substance, often glass and/or plastic, having two opposite surfaces either both curved or one curved and one plane, used in an optical device for changing the convergence and/or focal point of light rays; and/or an optical device with approximate axial symmetry that transmits light, refracts light, and is adapted to cause the light to concentrate and/or diverge.
less than—having a measurably smaller magnitude and/or degree as compared to something else.
located—situated in a particular spot, region, and/or position.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine-implementable instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine-implementable instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine-implementable instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine-implementable instructions—directions adapted to cause a machine, such as an information device, to perform one or more particular activities, operations, and/or functions via forming a particular physical circuit. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied and/or encoded as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain one or more machine-implementable instructions, data, and/or information. Examples include a memory device, punch card, player-plano scroll, etc.
material—a substance and/or composition.
maximum—a greatest extent.
may—is allowed and/or permitted to, in at least some embodiments.
measurement—a value of a variable, the value determined by manual and/or automatic observation.
mediate—bring about.
membrane—a skin-like thin film which acts as a barrier or container wall. A relatively thin film which serves to define a barrier or container wall to at least one of the constituents of a solution or colloidal suspension.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
move—to transfer from one location to another.
negative—less than approximately zero.
neither—not the one nor the other of two people or things; not either;

and/or used before the first of two (or occasionally more) alternatives that are being specified (the others being introduced by “nor”) to indicate that they are each untrue or each do not happen
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, radio, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, 3G, 4G, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
nor—used before the second or further of two or more alternatives (the first being introduced by a negative such as “neither” or “not”) to indicate that they are each untrue or each do not happen.
operable—able to be normally operated.
optic—a lens and/or other optical component in an optical instrument and/or system.
optical—of or relating to light, sight, and/or a visual representation.
optical substrate—a material from which an optic is made. Any material that is substantially transparent at the working wavelength can be used as an optical substrate.
optical system—a combination of two or more similar and/or diverse optical elements which are optically related.
out—through to the outside.
out of—moving and/or situated away from a place, typically one that is enclosed and/or hidden.
outer—farther than another from the center and/or middle.
over—with reference to.
packet—a generic term for a bundle of data organized in a specific way for transmission, such as within and/or across a network, such as a digital packet-switching network, and comprising the data to be transmitted and certain control information, such as a destination address.
parabola—the path of a point moving such that its distance from a fixed point always equals its perpendicular distance from a fixed straight line not containing the fixed point.
paraboloid—a body of revolution generated by rotating a parabola about its axis of symmetry.
parallel—of, relating to, or designating lines, curves, planes, and/or or surfaces everywhere equidistant and/or an arrangement of components in an electrical circuit that splits an electrical current into two or more paths.
parameter—a sensed, measured, and/or calculated value.
partitioned—divided into parts.
path—a physical route, a logical route, and/or an imaginary line between two or more objects.
perceptible—capable of being perceived by the human senses.
perfectly—in a manner and/or way that could not be better.
phase—the relationship in time between the successive states and/or cycles of an oscillating and/or repeating system (such as an alternating electric current, a light wave, and/or a sound wave), a fixed reference point, the states, and/or cycles of another system with which it may or may not be in synchrony.
physical—tangible, real, and/or actual.
physically—existing, happening, occurring, acting, and/or operating in a manner that is tangible, real, and/or actual.
planar—shaped as a substantially flat two-dimensional surface.
plurality—the state of being plural and/or more than one.
portion—a part, component, section, percentage, ratio, and/or quantity that is less than a larger whole. Can be visually, physically, and/or virtually distinguishable and/or non-distinguishable.
positive—greater than approximately zero.
power—a measure of an ability of a vision system, eye, lens, and/or lens-assisted eye, to refract, magnify, separate, converge, and/or diverge; and/or a general term that may refer to any power such as effective, equivalent, dioptric, focal, refractive, surface, and/or vergence power.
predetermined—established in advance.
pressure—a measure of force applied uniformly over a surface.
probability—a quantitative representation of a likelihood of an occurrence.
processor—a machine that utilizes hardware, firmware, and/or software and is physically adaptable to perform, via Boolean logic operating on a plurality of logic gates that form particular physical circuits, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
produce—to create.
profile—a graphical and/or other representation of information relating to a particular characteristic of something, recording in quantified form; a representation, outline, and/or description of an object, structure, and/or surface.
project—to calculate, estimate, or predict.
provide—to furnish, supply, give, and/or make available.
pump—a machine or device for raising, compressing, and/or transferring one or more fluids.
radius—a distance from an approximate center of an object to a curved boundary of the object.
range—a defined interval characterized by a predetermined maximum value and/or a predetermined minimum value.
receive—to get as a signal, take, acquire, and/or obtain.
recommend—to suggest, praise, commend, and/or endorse.
render—to, e.g., physically, chemically, biologically, electronically, electrically, magnetically, optically, acoustically, fluidically, and/or mechanically, etc., transform information into a form perceptible to a human as, for example, data, commands, text, graphics, audio, video, animation, and/or hyperlinks, etc., such as via a visual, audio, and/or haptic, etc., means and/or depiction, such as via a display, monitor, electric paper, ocular implant, cochlear implant, speaker, vibrator, shaker, force-feedback device, stylus, joystick, steering wheel, glove, blower, heater, cooler, pin array, tactile touchscreen, etc.
repeatedly—again and again; repetitively.
request—to express a desire for and/or ask for.
response—a reaction, reply, and/or answer to an influence and/or impetus.
same—substantially identical; not substantially different; substantially unchanged; and/or of an identical type.
second—a cited element of a set that follows an initial element.
select—to make a choice or selection from alternatives.
sensor—a device adapted to automatically sense, perceive, detect, and/or measure a physical property (e.g., pressure, temperature, flow, mass, heat, light, sound, humidity, proximity, position, velocity, vibration, loudness, voltage, current, capacitance, resistance, inductance, magnetic flux, and/or electro-magnetic radiation, etc.) and convert that physical quantity into a signal. Examples include position sensors, proximity switches, stain gages, photo sensors, thermocouples, level indicating devices, speed sensors, accelerometers, electrical voltage indicators, electrical current indicators, on/off indicators, and/or flowmeters, etc.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
shape—a characteristic surface, outline, and/or contour of an entity.
signal—(v) to communicate; (n) one or more automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that can encode information, such as machine-implementable instructions for activities and/or one or more letters, words, characters, symbols, signal flags, visual displays, and/or special sounds, etc., having prearranged meaning Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
solid—neither liquid nor gaseous, but instead of definite shape and/or form.
special purpose computer—a computer and/or information device comprising a processor device having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
special purpose processor—a processor device, having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
spherical—of or relating to the properties of spheres; having a shape as though having been formed inside and/or on the surface of a sphere; and/or resembling a segment of a sphere and/or a part-spherical portion of a sphere divided by a plane (or more generally, a surface) that intersects a sphere at any location.
store—to place, hold, and/or retain data, typically in a memory.
substantially—to a considerable, large, and/or great, but not necessarily whole and/or entire, extent and/or degree.
substrate—a material which provides the surface on which something is deposited, inscribed, or acted upon.
support—to bear the weight of, especially from below.
surface—any face and/or outer boundary of a body, object, and/or thing
switch—(v) to: form, open, and/or close one or more circuits; form, complete, and/or break an electrical and/or informational path; select a path and/or circuit from a plurality of available paths and/or circuits; and/or establish a connection between disparate transmission path segments in a network (or between networks); (n) a physical device, such as a mechanical, electrical, and/or electronic device, that is adapted to switch.
system—a collection of mechanisms, devices, machines, articles of manufacture, processes, data, and/or instructions, the collection designed to perform one or more specific functions.
transform—to change in measurable: form, appearance, nature, and/or character.
transition—to undergo and/or cause to undergo a process and/or period of change.
transitioning—(n) a process and/or a period of changing from one state and/or condition to another.
transmissive—allowing waves to pass through; and/or not substantially reflecting and/or absorbing.
transmit—to send as a signal, provide, furnish, and/or supply.
tune—adjust and/or adapt to a particular purpose and/or situation.
uniform—relatively homogenous.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
value—a measured, provided, assigned, determined, and/or calculated quantity or quality for a variable and/or parameter.
valve—a device that regulates flow through a pipe and/or through an aperture by opening, closing, and/or obstructing a port and/or passageway.
variable—(n) a property, parameter, and/or characteristic capable of assuming any of an associated set of values; and/or (adj.) likely to change and/or vary; subject to variation; and/or changeable.
via—by way of and/or utilizing.
volume—a quantity of space that a substance may occupy.
wavefront—a surface containing points affected in substantially the same way by a wave at a substantially predetermined time.
weight—a value indicative of importance.
wherein—in regard to which; and; and/or in addition to.
while—for as long as, during the time that, and/or at the same time that.
with—accompanied by.

### Note

Various substantially and specifically practical and useful exemplary embodiments of the claimed subject matter are described herein, textually and/or graphically, including the best mode, if any, known to the inventor(s), for implementing the claimed subject matter by persons having ordinary skill in the art. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects skilled artisans to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”;
any two or more described substances can be mixed, combined, reacted, separated, and/or segregated;
any described characteristics, functions, activities, substances, and/or structural elements can be integrated, segregated, and/or duplicated;
any described activity can be performed manually, semi-automatically, and/or automatically;
any described activity can be repeated, any activity can be performed by multiple entities, and/or any activity can be performed in multiple jurisdictions; and
any described characteristic, function, activity, substance, and/or structural element can be specifically excluded, the sequence of activities can vary, and/or the interrelationship of structural elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any phrase (i.e., one or more words) appearing in a claim is followed by a drawing element number, that drawing element number is exemplary and non-limiting on claim scope.

No claim of this document is intended to invoke paragraph six of 35 USC 112 unless the precise phrase “means for” is followed by a gerund.

Any information in any material (e.g., a United States patent, United States patent application, book, article, etc.) that has been incorporated by reference herein, is incorporated by reference herein in its entirety to its fullest enabling extent permitted by law yet only to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. A system comprising:
a fluidic lens comprising:
an optical substrate comprising a first portion and a second portion, the first portion of the optical substrate defining a first inner surface and a first outer surface and the second portion of the optical substrate defining a second inner surface and a second outer surface;
a flexible elastic membrane, wherein:
the flexible elastic membrane is adapted to substantially bisect a cavity, the cavity bounded by the first inner surface and the second inner surface,
the flexible elastic membrane is adapted to, in response to being deformed by a first pressure operably generated by a first optical fluid and/or a second pressure operably generated by second optical fluid acting on the flexible elastic membrane: come into substantial contact with the first inner surface, come into substantial contact with the second inner surface, or assume a substantially flat shape and/or substantially spherical shape while substantially contacting neither the first inner surface nor the second inner surface, wherein a radius of the substantially spherical shape is defined by a difference between the first pressure and the second pressure.

2. A system of claim 1, wherein:
an optical power of the fluidic lens is a function of:
a shape of the first inner surface,
a shape of the second inner surface,
a volume of the first optical fluid in a first inner chamber bounded by the first inner surface and the flexible elastic membrane,
a volume of the second optical fluid in a second inner chamber bounded by the second inner surface and the flexible elastic membrane,
a refractive index of the first optical fluid, and
a refractive index of the second optical fluid.

3. A system of claim 1, wherein:
the first inner surface defines a substantially parabolic shape.

4. A system of claim 1, wherein:
the second inner surface defines a substantially parabolic shape.

5. A system of claim 1, wherein:
the optical substrate defines a first outer surface and a second outer surface;
the first outer surface and/or the second outer surface are adapted to be substantially planar shaped; and
the optical substrate is solid.

6. A system of claim 1, further comprising:
a first inner chamber bounded by the first inner surface and the flexible elastic membrane;
a second inner chamber bounded by the second inner surface and the flexible elastic membrane, wherein:
a refractive index of the first optical fluid is different from a refractive index of the second optical fluid;
the refractive index of the first optical fluid is less than a refractive index of the optical substrate;
the refractive index of the second optical fluid is greater than the refractive index of the optical substrate;
the optical substrate comprises a first channel adapted to convey the first optical fluid into and/or out of the first inner chamber; and/or
the optical substrate comprises a second channel adapted to convey the second optical fluid into and/or out of the second inner chamber.

7. A system of claim 1, wherein:
a refractive index of the first optical fluid is different from a refractive index of the second optical fluid;
the refractive index of the first optical fluid is less than a refractive index of the first portion of the optical substrate and/or a refractive index of the second portion of the optical substrate;
the refractive index of the second optical fluid is greater than the refractive index of the second portion of the optical substrate and/or the refractive index of the first portion of the optical substrate.

8. A system of claim 1, wherein:
a refractive index of the first portion of the optical substrate is the same as a refractive index of the second portion of the optical substrate.

9. A system of claim 1, further comprising:
a tunable electro-active lens located in the same optical path as the fluidic lens.

10. A system of claim 1, further comprising:
a first sensor adapted to detect and/or measure a variable associated with the cavity, the flexible elastic membrane, the first optical fluid, and/or the second optical fluid.

11. A system of claim 1, further comprising:
a first controller adapted to control a variable of the cavity, the flexible elastic membrane, the first optical fluid, and/or the second optical fluid.

12. A system of claim 1, further comprising:
a first valve adapted to mediate a flowrate of the first optical fluid and/or a flowrate of the second optical fluid.

13. A system of claim 1, further comprising:
a first pump adapted to increase a pressure of the first optical fluid and/or the second optical fluid sufficiently to flex the flexible elastic membrane a predetermined amount.

14. A method comprising:
transitioning an optical power of a fluidic lens from a positive value to a negative value over a substantially continuous range of values,
wherein:
entry of a first optical fluid into a first portion of a cavity substantially displaces a second optical fluid from a second portion of the cavity;
the first portion of the cavity is defined by a first portion of an optical substrate and a flexible elastic membrane;
the second portion of the cavity is defined by a second portion of the optical substrate and the flexible elastic membrane;
the first optical fluid is partitioned from the second optical fluid by the flexible elastic membrane;
the flexible elastic membrane is comprised of a substantially optically transmissive material;
the first portion and/or the second portion of the of the optical substrate are comprised of a substantially optically transmissive material;
the first optical fluid has a refractive index less than the refractive index of the first portion of the optical substrate;
the second optical fluid has a refractive index greater than the refractive index of the first portion of the optical substrate;
at a predetermined maximum positive value of the optical power the flexible elastic membrane is substantially in contact with a first inner surface of the first portion of the optical substrate; and
at a predetermined maximum negative value of the optical power the flexible elastic membrane is substantially in contact with a second inner surface of the second portion of the optical substrate.

15. A method of claim 14, further comprising:
providing the substantially continuous range of optical powers, a spherical aberration at each optical power within said range of optical powers less than a spherical aberration of a perfectly spherical lens having a continuously uniform radius, wherein:
the first inner surface of the first portion of the optical substrate and/or the second inner surface of the second portion of the optical substrate are parabolic in shape.

16. A method of claim 14, further comprising:
causing a predetermined point on the flexible elastic membrane to displace by a predetermined amount in a predetermined direction.

17. A method of claim 14, further comprising:
pumping the first optical fluid into the first portion of the cavity,
pumping the first optical fluid out of the first portion of the optical cavity,
pumping the second optical fluid into the second portion of the cavity, and/or
pumping the second optical fluid out of the second portion of the optical cavity.
